(19) United States
(12) Patent Application Publication
(10) Pub. No.: US 2016/0357029 A1
(43) Pub. Date: Dec. 8, 2016

(54) CONTACT LENS FOR PRESBYOPIA

(71) Applicant: O-SUB KOO, SEOUL (KR)

(72) Inventor: O-SUB KOO, SEOUL (KR)

(21) Appl. No.: 14/789,469

(22) Filed: Jul. 1, 2015

(30) Foreign Application Priority Data
Jun. 5, 2015 (KR) 10-2015-0079270

(51) Int. Cl. G02C 7/04

(52) U.S. Cl. CPC G02C 7/042; G02C 7/049

(57) ABSTRACT

The present, invention relates to a contact lens for presbyopia including: a lens foody; long distance portions and short distance portions arranged on the lens body, the long distance portions having refraction for long distance and the short distance portions having refraction for short distance, wherein the lens body is divided into concentric circles as well as in top/bottom and left/right directions and the long distance portions and the short distance portions are arranged repeatedly and alternately on the neighboring divisions on the lens body.

### BACKGROUND OF THE INVENTION

Field of the Invention

The present invention relates to a contact lens for presbyopia, and more particularly, to a contact lens for presbyopia that provides a plurality of indexes of refraction to a lens body contacted with the cornea, irrespective of the decentering of the lens body from the center of the cornea or the changes of the size of the pupil, thus allowing objects located at long and short distances to be clearly seen.

Background of the Related Art

Generally, the human eye is almost similar to the structure of a camera. For example, the iris serving as the aperture of the camera is located inside the cornea and the sclera disposed on the front side of the eye and adjusts an quantity of light, the crystalline lens serving as the lens of the camera performs the refraction of light to form images on the retina, the retina serving as a film of the camera allows the light passing through the cornea and the crystalline lens to form the images, and the ciliary body serving as a distance controller of the camera changes the thickness of the crystalline lens to allow the images of objects to be accurately formed.

By the way, the camera adjusts the distance between the lens and the film so as to obtain, the accurate formation of the image of the object, while moving the glass lens forward and backward, and contrarily, the crystalline lens of the human eye having the similar function to the lens of the camera is changed in thickness so as to accurately form the image on the retina, while being fixed to the ciliary body.

That is, the crystalline lens has a shape of an elastic convex lens having a thickness of about 4 mm and adjusts the degree of refraction of the light passing through the sclera. If the object like characters or articles is at a short distance, the ciliary body is contracted to make the crystalline lens become thick, thus increasing the degree of refraction of the light, and contrarily, if the object like characters or articles is at a long distance, the ciliary body is relaxed to make the crystalline lens become thin, thus decreasing the degree of refraction of the light. Accordingly, the crystalline lens is repeatedly contracted and relaxed whenever the distances of the object are varied and thus focused on the object to allow the objects to be clearly seen.

In case of the healthy eye, the thickness of the crystalline lens is automatically adjusted and focused well when the object located at short or long distance is seen. As the human eye is aged, however, the crystalline lens is also aged to provide a low degree of elasticity and is not adjusted well in thickness, so that when the object located at short distance is seen, the focus on the object is not well obtained to cause the object to be not vividly seen or even not seen well.

So as to solve these problems, generally, presbyopia is corrected through eyeglasses or contact lenses. In case of the eyeglasses, a multi-focal lens (progressive lens) is provided to contain two or more lens powers in a single lens to help a user see objects at short, intermediate, and long distances, and contrarily, in case of the contact lens, there are some difficulties in the correction of presbyopia,

In more detail, general contact lenses have the same lens powers over the whole region thereof, bat the contact lens for presbyopia has different powers on the center and the 15 peripheral region thereof or applies short vision (short viewing zone; power to the lower end thereof and long vision (long viewing zone) power to the upper end thereof, so that the pupil moves to achieve the vision correction at short and long distances.

At this time, the pupil should accurately pass through the short viewing zone or the long viewing zone of the contact lens to form vivid images, but while being used, the contact lens is often decentered from the center of the cornea and thus located at the periphery of the cornea.

Particularly, a hard lens is not brought into close contact with the cornea due to a thick tear film formed between the lexis and the cornea, so that the hard lens becomes decentered upon blinking to cause the object to be not seen well, thus making it inconvenient to relocate the lens to the center of the cornea. If the period of the blinking is extended, further, the restoring force of the lens becomes decreased, and the movements of the lens to the upper or lower side of the cornea become increased.

Furthermore, the contact lens users have different pupil or cornea sizes from each other, so that appropriate presbyopia powers should be applied to the different pupil or cornea sizes.

In addition to the multi-focal lens, moreover, there is recently suggested a pinhole lens on which a pinhole pattern is printed on a general soft lens to reduce the passage along which light enters, thus providing clear images, and otherwise; there is introduced camera inlay wherein a donut-shaped lens is inserted inside the cornea to pass the focused light therethrough, thus correcting the near and intermediate vision. By the way, if the pinhole lens moves from the center of the cornea, it does not provide good effects thereof, and in case of the camera inlay, it is very inconvenient in the maintenance thereof after the surgery, the fear and prejudice of the surgery may be produced, and high surgery cost is needed.

If the user's pupil size is large, further, the pupil is expanded in the night to cause light bleed or moon halo, and contrarily, if his or her pupil size is small, images are not clearly formed, while being under the power of the center of the contact lens.

### SUMMARY OF THE INVENTION

Accordingly, the present invention has been made in view of the above-mentioned problems occurring in the prior art, and it is an object of the present invention to provide a contact lens for presbyopia that can be provided with just simple configuration, thus performing the vision correction for the long and short distances at the same time.

It is another object of the present invention to provide a contact lens for presbyopia that is capable of allowing objects located at long and short distances to be clearly seen even, when a lens body is decentered from the center of the cornea or the sizes of the pupil are changed.

To accomplish the above-mentioned objects, according to the present invention, there is provided a contact lens for presbyopia including; a lens body; long distance portions and short distance portions arranged on the lens body, the long distance portions having refraction for long distance and the short distance portions having refraction for short distance, wherein the lens body is divided into concentric circles as well as in top/bottom and left/right directions and the long distance portions and the short distance portions are arranged repeatedly and alternately on the neighboring divisions on the lens body.

According to the present invention, preferably, the lens body includes a plurality of micropores formed on the entire surface thereof so as to perform air transmission and nutrients supply.

### BRIEF DESCRIPTION OF THE DRAWINGS

The above and other objects, features and advantages of the present invention will be apparent from, the following detailed description of the preferred embodiments of the invention in conjunction with the accompanying drawings, in which:

FIG. 1 is a perspective view showing a contact lens for presbyopia according to the present invention;

FIG. 2 is an exemplary view showing the state wherein focuses are formed by means of light, passing through long distance portions and short distance portions of the contact lens for presbyopia according to the present invention;

FIG. 3 is an exemplary view showing use states of the contact lens for presbyopia according to the present invention; and

FIG. 4 is an exemplary view showing other use states of the contact lens for presbyopia according to the present invention.

### DETAILED DESCRIPTION OF THE PREFERRED EMBODIMENTS

Hereinafter, an explanation on a contact lens for presbyopia according to the present invention will be in detail given with reference to the attached drawing. Before the present invention is disclosed and described, however, it is to be understood that the disclosed embodiments are merely exemplary of the invention, which can be embodied in various forms.

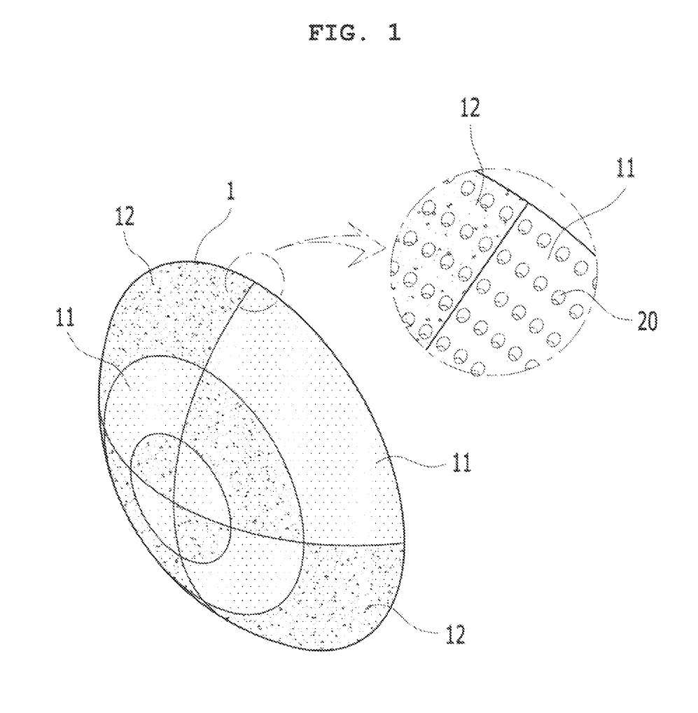

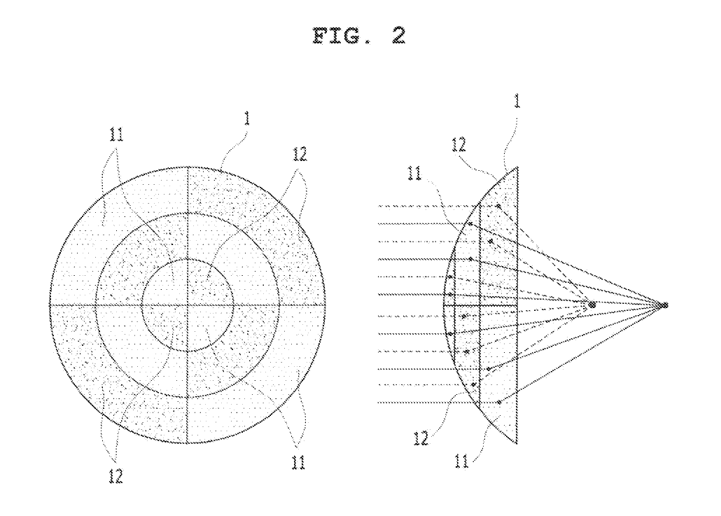

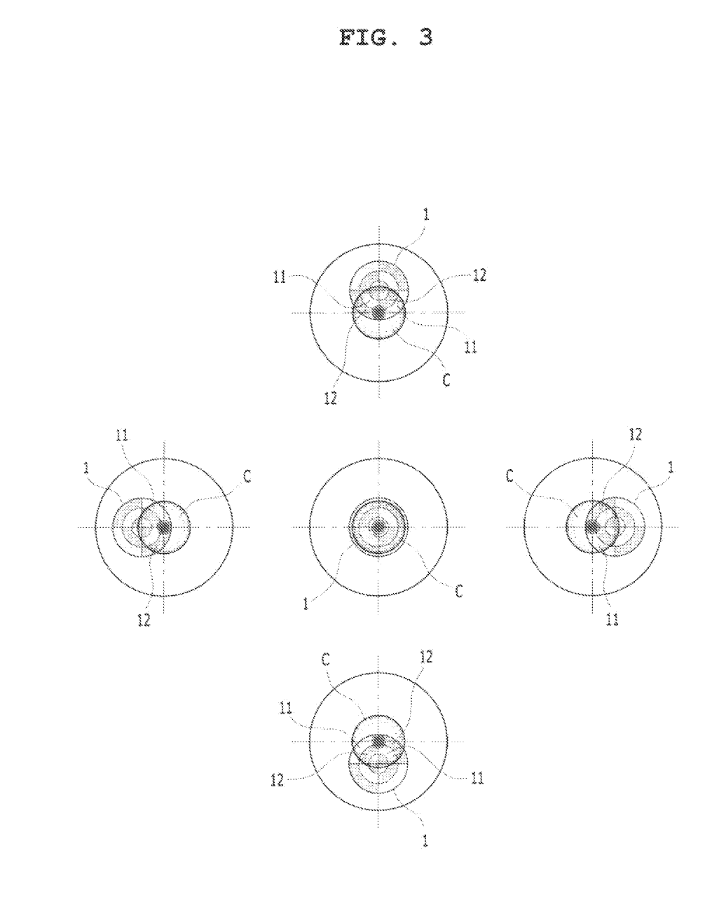

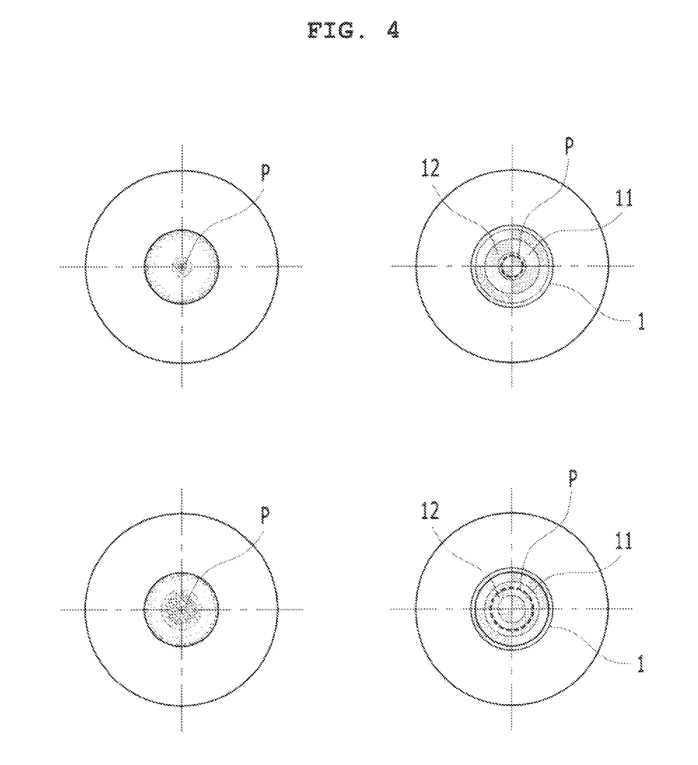

FIG. 1 is a perspective view showing a contact lens for presbyopia according to the present invention, FIG. 2 is an exemplary view showing the state wherein focuses are formed by means of light passing through long distance portions and short distance portions of the contact lens for presbyopia according to the present invention, FIG. 3 is an exemplary view showing use states of the contact lens for presbyopia according to the present invention, and FIG. 4 is an exemplary view showing other use states of the contact lexis for presbyopia according to the present invention.

As shown, a contact lens for presbyopia according to the present invention includes a lens body 1 and long distance portions 11 and short distance portions 12 having different powers from each other arranged on the lens body lf wherein the lens body 1 is divided into concentric circles as well as top/bottom and left/right directions and the long distance portions 11 and the short distance portions 12 are arranged alternately on the neighboring divisions on the lens body 1.

In more detail, the contact lens for presbyopia according to the present invention will be explained.

First, the lens body 1 is tightly attached to a user's cornea so as to perform his or her vision correction, and accordingly, the inner peripheral surface of the lens body 1 corresponds to the shape of the surface of the cornea.

The lens body 1 has a diameter of 12.0 to 15.0 mm and a base curve of 8.0 to 9.0 mm.

As shown in FIGS. 1 and 2, the lens body 1 is divided, on the surface thereof into a plurality of concentric circles and at the same time defined in top/bottom and left/right. directions, and the long distance portions 11 and the short distance portions 12 are arranged on the divided sections.

At this time, preferably, the long distance portions 11 and the short distance portions 12 are arranged repeatedly and alternately on the neighboring sections of the lens body 1.

The long distance portions 11 have refraction for allowing objects located at a long distance to be seen to provide given refraction power for long distance vision. The long distance portions 11 have the cower range of −10.0 to 4.0 D (diopter).

The short distance portions 12 have refraction for allowing objects located at a short distance to be seen to provide given refraction power for short distance vision. The short distance portions 12 for presbyopia correction have the power range of 1.0 to 4.0 D.

That is, the power of the short distance portions 12 is set up to 4.0 D in the unit of 0.5 D according to the user's vision, and if his or her presbyopia is seriously developed, the power of the short distance portions 12 is set close to 4.0 D).

Accordingly, the lens body 1 has the long distance portions 11 and the short distance portions 12 having different refraction arranged alternately at given distances on the range from the center thereof to the outer periphery thereof as well as in the top/bottom and left/right directions, thus providing a plurality of indexes of refraction. Accordingly, as shown in FIG. 2, if the user sees objects like characters or articles, he or she can clearly focus on both of long and short objects and further see the long and short objects at the same time.

Further, even if the lens body 1 moves toy a given distance in any one of top/bottom and left/right directions from the center C of the cornea due to the user's blinking, as shown in FIG. 3, the long distance portion portions 11 and the short distance portions 12 arranged on the outer periphery of the lens body 1 become located on the center C of the cornea, so that the pupil P accurately passes through the long distance portions 11 and the short distance portions 12 to allow focuses at long and short distances to be all formed.

Further, even, if the sizes of the pupil P are changed according to the brightness of light or even if they become small with the age, as shown in FIG. 4, focuses at the long and short distances can be all formed on the lens body 1, without having any influence by the power of the center of the lens body 1.

Under the above-mentioned configuration, the lens body 1 of the contact lens according to the present invention further has a plurality of micropores 20 formed spaced apart from each other on the entire surface thereof so as to transmit oxygen to the user's cornea and to supply nutrients necessary for the user's eye, so that even if the lens body 1 is worn for long hours, his or her eye is not easily dried, he or she does not feel any eye fatigue, and his or her cornea is kept in a healthy state.

The plurality of micropores 20 is formed by means of laser in the process of cutting a mold of the lens body 1 and each micropore 20 has a size of 8 to 12 μm. The number of micropores 20 is 15,000 to 16,000.

As set forth in the foregoing, the contact lens for presbyopia according to the present invention includes the lens body and the long distance portions and the short distance portions having different powers from each other arranged alternately in the directions of concentric circles as well as in the top/bottom and left/right directions, so that even though the characters or articles located at long and short distances are alternately seen, they can be easily distinguished, and the vision correction for the long and short distances can be easily achieved with the just simple configuration of the contact lens,

Moreover, even when the lens body is decentered from the center of the cornea, and even if the sizes of the pupil are changed according to the symptoms of presbyopia or the brightness of light, clear focuses are obtained, and further, the vision correction is achieved, without any surgery, thus providing psychological comfort and expense saving effects.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A contact lens for presbyopia comprising;
a lens body 1;
long distance portions 11 and short distance portions 12 arranged on the lens body 1, the long distance portions 11 having refraction for long distance and the short distance portions 12 having refraction for short distance,
wherein the lens body 1 is divided into concentric circles as well as in top/bottom and left/right directions and the long distance portions 11 and the short distance portions 12 are arranged repeatedly and alternately on the neighboring divisions on the lens body 1.

2. The contact lens for presbyopia according to claim 1, wherein the long distance portions 11 have the power range of −1.0 to 4.0 D.

3. The contact lens for presbyopia according to claim 1, wherein the short distance portions 12 have the power range of 1.0 to 4.0 D.

4. The contact lens for presbyopia according to claim 1, wherein the lens body 1 comprises a plurality of micropores 20 formed on the surface thereof so as to perform air transmission and nutrients supply.
5, The contact lens for presbyopia according to claim 4, wherein each micropore 20 has a size of 8 to 12 μm.

6. The contact lens for presbyopia according to claim 5, wherein the number of micropores 20 is 15,000 to 16/000.
